(19) United States
(12) Patent Application Publication
(10) Pub. No.: US 2018/0165609 A1
(43) Pub. Date: Jun. 14, 2018

(54) USING PROFILES TO MATCH PEOPLE WHO ARE LIKELY TO DO BUSINESS TOGETHER

(71) Applicant: BCD, LLC, Salt Lake City, UT (US)

(72) Inventors: David S. Monk, Farmington, UT (US); Beck Locey, Sandy, UT (US)

(21) Appl. No.: 15/517,495

(22) PCT Filed: Oct. 5, 2015
(86) PCT No.: PCT/US15/54056

§ 371 Date: Aug. 29, 2017

Related U.S. Application Data
(60) Provisional application No. 62/060,304, filed on Oct. 6, 2014.

(51) Int. Cl. G06Q 10/06; G06Q 40/06; G06Q 40/02; G06Q 30/02; G06Q 50/00

(52) U.S. Cl. CPC G06Q 10/063; G06Q 40/06; G06Q 50/01; G06Q 30/02; G06Q 40/02

(57) ABSTRACT

A profile matching website is provided which facilitates matching of participants with entrepreneurs using a resource profile to represent a participant's appointed resources. An entrepreneur can create one or more business opportunity profiles that each describes a different business opportunity. A participant can create multiple resource profiles that each may appoint a different amount of resources and/or in-kind skills that the participant wants to use to search for business opportunities. A resource profile can also be identified as followable to allow other participants to follow and potentially aggregate with the resource profile. A resource profile may also allow other participants to aggregate resources from their resource profiles with the resources of the followed resource profile. A resource profile may also be assigned a rating that represents previous interactions that the participant behind the resource profile has had with entrepreneurs or other participants within the profile matching website.

### BACKGROUND

Current business opportunity websites provide a venue for matching entrepreneurs with participants. In a typical business opportunity website, an entrepreneur can create a profile describing a business opportunity while a participant can create a profile identifying a willingness to participate in a business opportunity matching various criteria. The business opportunity website uses the descriptions of business opportunities and the criteria of the profiles of participants to match entrepreneurs with participants and vice versa.

Although business opportunity websites facilitate matching investors and participants, they are oftentimes only beneficial for participants having substantial capital to invest. For example, potential participants having relatively small amounts of money or in-kind skills may not benefit from using an business opportunity website because entrepreneurs are oftentimes unwilling or unable to select potential participants that can only provide an investment that is a fraction of the capital needed for a particular business opportunity. Similarly, even if a potential participant's criteria matches a business opportunity, the small amount of money that the potential participant can provide may not justify the transaction costs required to accept the investment.

### BRIEF SUMMARY

The present invention extends to methods, systems, and computer program products for implementing a profile matching website to match people who are likely to do business together. A profile may describe a business opportunity (business opportunity profile) for which an entrepreneur is seeking resources. A profile may also describe a resource (resource profile) that a participant is willing to contribute to a business opportunity. An entrepreneur (or business opportunity provider) can create multiple opportunity profiles that each may describe a different business opportunity. A participant (or resource provider) can create multiple resource profiles that each may appoint a different amount or type of resource that the participant may be willing to contribute to a business opportunity.

A resource profile can be identified as followable to allow other participants to follow the resource profile. A followable resource profile may also allow other participants to aggregate resources from their resource profiles with the resources of the followed profile thereby increasing the amount of resources that are appointed within the followed resource profile.

A resource profile may also be assigned a rating that represents previous interactions that the participant behind the resource profile has had with other entrepreneurs or participants within the profile matching website. The rating of a followed resource profile may be based on the ratings of the resource profiles that follow it. Likewise, the rating of a resource profile that includes aggregated resources may be based on the ratings of the resource profiles from which resources are aggregated. An entrepreneur may also preapprove a resource profile to encourage the aggregation of resources into the approved resource profile. A business opportunity profile may also be preapproved by a third party.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

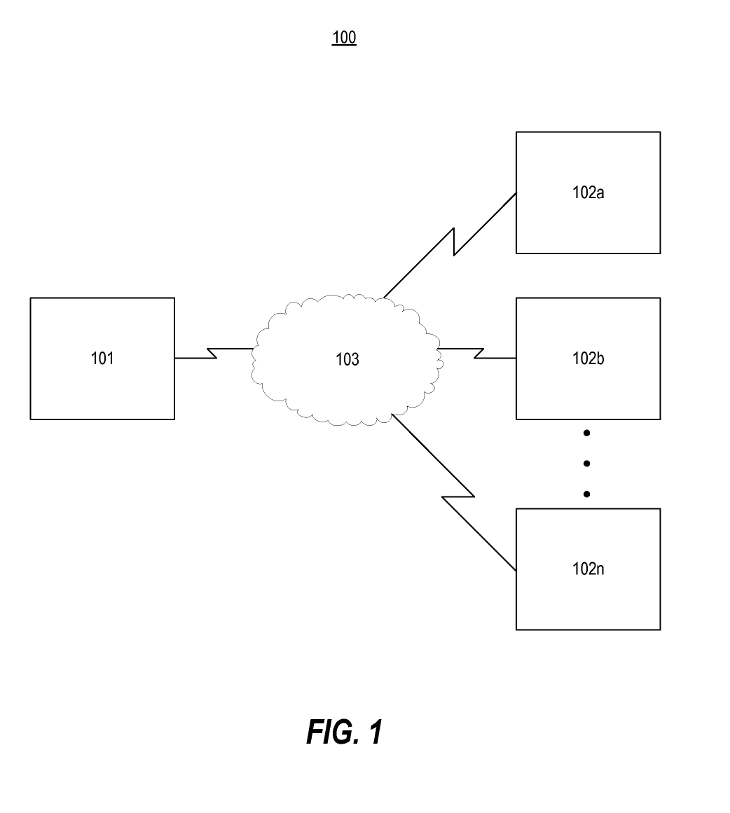

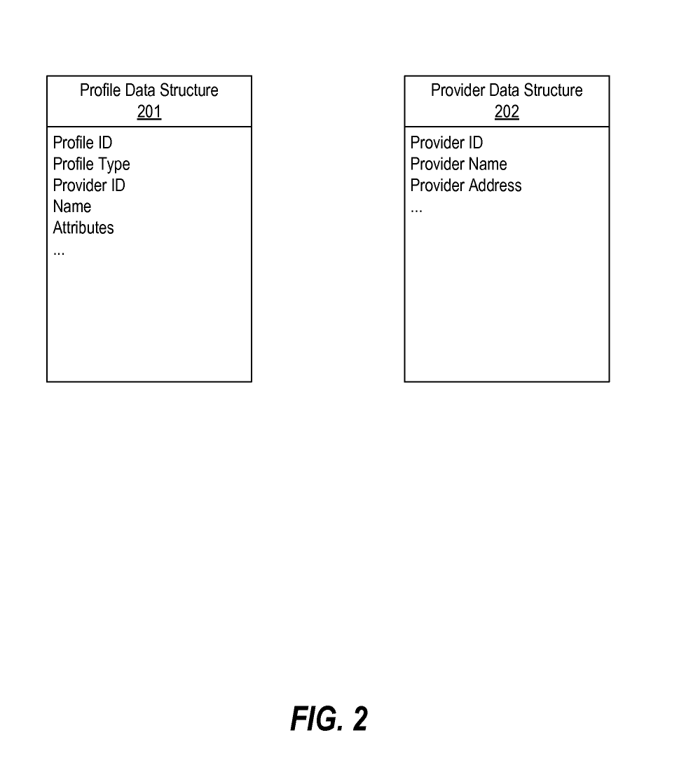

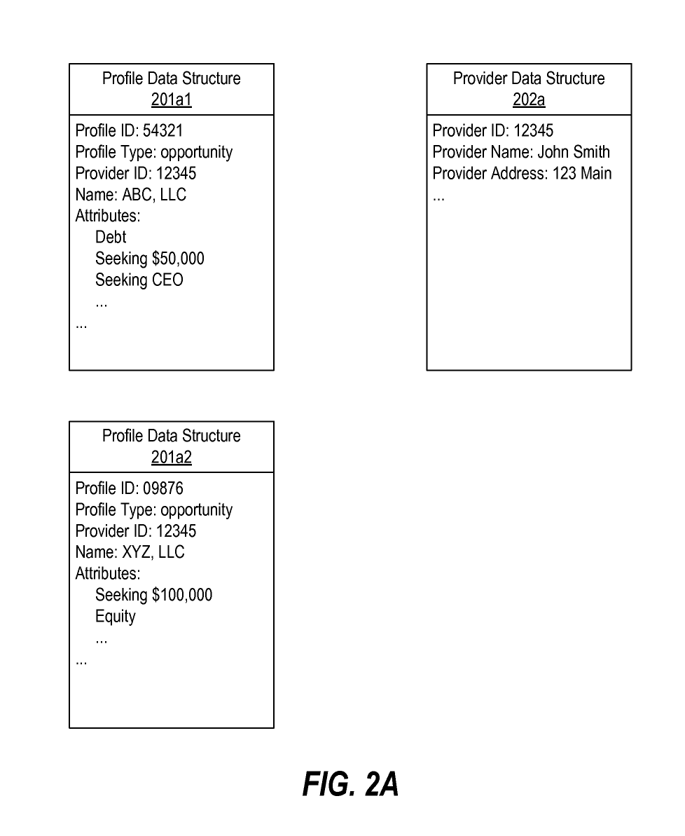

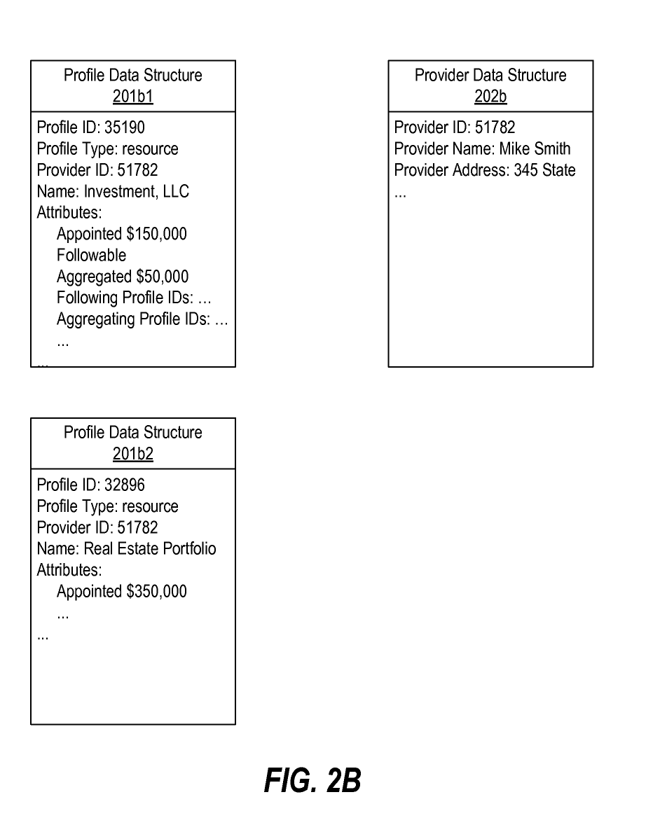

FIG. 1 illustrates an example computer environment 100 in which the present invention can be implemented. Computer environment 100 includes a server system 101, client systems 102a-102n, and a network 103 interconnecting server system 101 with client systems 102a-102n. Server system 101 can represent any number and configuration of server systems, devices, and/or components. For example, server system 101 can be a single server computing device or a cloud of server components. Similarly, client systems 102a-102n can represent the many different types of computing devices and systems that can communicate with server system 101 via network 103. For example, client systems 102a-102n may represent desktop computers, laptop computers, tablets, smart phones, etc. Network 103 can typically be the internet although other network connections, such as local connections, could also be employed.

Server system 101 can host a profile matching website. In this context, a website should be construed broadly to encompass not only content that is displayed via webpages, but also content that is displayed via a dedicated application such as a desktop or mobile application. Accordingly, a profile matching website includes any interface through which an end user can access the functionality described below.

In this specification, a participant (or resource provider) can be one or more individuals or entities. An entrepreneur (or business opportunity provider) may also be one or more individuals or entities. Appointing resources to a resource profile refers to the act of a participant associating a potential contribution (capital or in-kind skills) to one of the participant's own resource profiles. Watching a profile refers to the act of selecting one or more profiles for the purpose of anonymously receiving information and/or observing systemic activity associated with the profile. Following a resource profile refers to the act of any user (whether a participant, business opportunity provider, or another type of user) of the profile matching website associating himself, herself, or itself with a participant's resource profile for the purposes of receiving information about the followed resource profile and/or providing information to the participant behind the followed resource profile. Aggregating resources refers to the act of a participant associating all or part of the resources from one of the participant's resource profiles with another participant's resource profile.

In accordance with embodiments of the present invention, a participant can create one or more resource profiles within the profile matching website. A resource profile comprises a potential contribution to be used to search for matching business opportunity profiles within the profile matching website. In contrast to current matching websites, the present invention enables a participant to create multiple resource profiles each with potentially different criteria. In this way, a single participant can easily diversify a search for business opportunity profiles.

A business opportunity profile is created by an entrepreneur and defines a business opportunity to which a participant may be willing to contribute. For example, a business opportunity profile can describe a proposed startup company, a franchise opportunity, or an existing company that is seeking additional funding or services for further growth. A business opportunity profile can specify, for example, an amount of money or one or more types of in-kind services that the entrepreneur is seeking for a business opportunity described in the business opportunity profile as well as various terms or criteria defining the desired type of funding or services.

A resource profile appoints a resource and is not a commitment to provide the appointed resource. Instead, the resource profile serves as an object against which searches can be performed to identify matches between business opportunity and resource profiles. This matching can be based on the amount appointed/sought and possibly many other criteria including the terms of funding (e.g. debt vs. equity, fixed vs. variable interest rate, term vs. balloon repayment, personal guarantee, option to convert loan to equity, percentage of company, management involvement, etc.), the industry or type of business, whether the business is a startup or is established, the size of the business, the type of growth activity being funded (e.g. mezzanine capital, start franchising, growth by merger, acquisition, etc.), capabilities offered by a participant, geographic location, in-kind-skills requested, etc.

Because a resource profile does not have a one-to-one relationship with a participant, the present invention enables a participant to easily explore many different opportunities and potentially diversify searches across many different business opportunity profiles. For example, if a participant has a total of $100,000 that he would like to contribute, he can create a first resource profile with an appointment of $70,000, a second resource profile with an appointment of $30,000 and management services, and a third resource profile with an appointment of accounting services. With each of these resource profiles, the participant may specify different criteria. For example, for the first resource profile, he may specify an interest in startup technology in exchange for equity. For the second resource profile, he may specify an interest to loan $30,000 to an existing company that is seeking management help in any field on terms to be determined. For the third resource profile, he may specify an interest to contribute the accounting services in any company for specific terms.

The profile matching website can allow both participants and entrepreneurs to search for matches with their resource and business opportunity profiles respectively. In some embodiments, once a resource provider identifies a desired business opportunity profile, or an entrepreneur identifies a desired resource profile, the participants can interact via the website to reach a potential future agreement based on the criteria/objectives specified in the profiles. However, in other embodiments, the participant and entrepreneur can negotiate criteria/terms beyond what is specified in the profiles. For example, a resource profile may specify that the participant is willing to invest $50,000 for a 20% stake in a company. The entrepreneur may be interested in receiving the resource but is only willing to give up 15% of the company. This type of negotiating can be performed via the website until a preliminary agreement has been reached on potential terms acceptable to both parties.

Once a preliminary agreement has been reached, or the interests of the parties is sufficient to justify further communications, the profile matching website can release contact information of the parties to each other to allow the parties to directly contact each other. In some embodiments, the release of the contact information can trigger the billing of a charge to either or both of the entrepreneur and participant. In such embodiments, the entrepreneur and participant can be free to explore resources and business opportunities respectively including negotiating terms with the corresponding participant and entrepreneur respectively without the concern of being further billed.

In some embodiments, the profile matching web site can allow an entrepreneur to select multiple resource profiles for a business opportunity. For example, an entrepreneur may create a business opportunity profile that specifies a desire to receive $100,000 for a 20% share in a startup company. The profile matching website can identify various resource profiles that match criteria of the business opportunity profile. These matching resource profiles may include those that have appointed resources matching the desired amount specified in the business opportunity profile and/or may include those that match other criteria regardless of an appointed amount. By matching resource profiles with appointed resources less than the desired amount, entrepreneurs can be allowed to identify a number of resource profiles with appointed amounts that when combined meet or exceed the desired $100,000.

The entrepreneur may then engage in negotiations with the participants behind multiple matching resource profiles. In some embodiments, these negotiations can be kept private between the participant and the entrepreneur thereby allowing the entrepreneur to reach agreeable terms with a participant independent of any other potential participants. However, in other instances, the negotiations between one participant and the entrepreneur may be visible to one or more other negotiating participants or possibly to any participant registered with the website. Making negotiations visible to other participants can assist entrepreneurs and participants alike in reaching agreeable terms, and in some instances, can protect unsophisticated participants or entrepreneurs from being taken advantage of.

In some embodiments, the profile matching web site can provide the entrepreneur with an option to engage in a bidding process during negotiations with the participants behind multiple resource profiles. For example, if the entrepreneur is pursuing a loan and is negotiating with five participants behind five resource profiles, the entrepreneur may initially specify (e.g. when creating the business opportunity profile) a single fixed interest rate (along with other terms/conditions). Each participant may have the option to express acceptance of the specified rate or to propose a different rate (or other term/condition). Each proposed term can be visible to each participant thereby allowing the other participants to propose better terms. Even after the entrepreneur reaches a preliminary agreement with a participant on current proposed terms, other participants may continue proposing different terms in an attempt to reach agreement with the entrepreneur. In some embodiments, participants are able to accept the current terms up until a certain amount of appointed resources have been obtained. This certain amount may be the same as the desired amount specified in the business opportunity profile or may be another (e.g. a greater) amount defined by the entrepreneur.

In some embodiments, the profile matching website can provide a participant with the option of aggregating resource profiles of multiple participants. For example, a participant can identify a resource profile as allowing aggregation. This designation also permits it to be followed which is further described below. A resource profile that allows aggregation is one that allows the appointed resources of another resource profile to be aggregated with the appointed resources of the followed resource profile. A participant may identify his resource profile as allowing aggregation in situations where the participant desires to control negotiations with an entrepreneur but desires access to more resources than are appointed in a corresponding resource profile. Resource profiles allowing aggregation can be made visible to other participants to allow the other participants to follow and potentially aggregate resources from their resource profiles. The participant behind the followed resource profile can request aggregation from a participant behind a following resource profile. If the following participant agrees to aggregate resources, he or she can choose to appoint all or part of the resources in the following resource profile to be aggregated with the resources in the followed resource profile.

The act of aggregation requires that both participants behind the respective resource profiles agree to mutually agreeable terms for aggregated resources. If either party does not agree, the request for aggregation fails and the appointed resources of the following resource profile are not aggregated with the appointed resources of the followed resource profile. If both parties agree to the terms for resource aggregation, the participant behind the following resource profile can choose to aggregate all or part of the resources in the following resource profile (an “aggregation amount”) with the resources of the followed resource profile. Once the participant behind the following resource profile selects an aggregation amount, the resources in the followed resource profile can be increased by the aggregation amount while the resources in the following resource profile can be decreased by the aggregation amount. Decrementing the aggregation amount from a following resource profile can prevent a participant from overcommitting a resource.

As an example of aggregating resources, a first participant may create a first resource profile that appoints $50,000 and then identify that the first resource profile allows aggregation. A second participant with a second resource profile that appoints $5,000 may then choose to follow the first resource profile and then aggregate the $5,000 appointed in the second resource profile with the resources appointed in the first resource profile. This aggregation will cause the $5,000 of capital appointed in the second resource profile to be aggregated with the $50,000 of capital appointed in the first resource profile. Then, an entrepreneur, when viewing the first resource profile, will see that the first resource profile includes $55,000 of appointed capital. The entrepreneur may negotiate with the first participant to reach an agreement on proposed terms regarding the provision of the $55,000. In this way, the first participant can represent the second participant in the negotiation process.

This aggregation of resource profiles can facilitate investing by participants that may not have substantial amounts of money. For example, an entrepreneur may not desire to negotiate with a participant whose resource profile appoints a small amount of money. However, by aggregating with another resource profile, many more business opportunity profiles can be matched. This is also true of participants that may not be sophisticated. For example, an unsophisticated participant may not want to negotiate or may not be capable of negotiating (both prior to reaching a preliminary agreement within the profile matching website and after when formalizing the terms of a potential agreement outside of the profile matching website) with an entrepreneur. By aggregating with another resource profile, the entrepreneur can be relieved of the task of negotiating while still being able to participate. Additionally, as stated above, aggregating can facilitate larger pools of resources than may otherwise be possible. For example, one participant may have a substantial reputation and would therefore be trusted by entrepreneurs seeking large contributions, but may lack the required resources for a particular business opportunity profile. By allowing many participants to aggregate their resource profiles with his resource profile, the participant may aggregate sufficient resources into a single resource profile to attract a large business opportunity profile.

In some embodiments, a resource profile that includes aggregated resources may distinguish between resources appointed by the resource provider and resources aggregated from another resource profile. For example, a first resource profile may indicate that $50,000 of $75,000 of appointed capital is appointed by the first participant while $20,000 is following but not yet aggregated from one or more resource profiles, and the remaining $5,000 is aggregated from one or more other resource profiles. Distinguishing appointed, following, and aggregated resources in this manner can provide a better indication to the entrepreneur of the risk of negotiating with the first participant. For example, if the amount of appointed resources in a resource profile includes a large percentage of following resources, the entrepreneur can be made aware of the risk that the followed participant may not be able to obtain all of the following but not yet aggregated resources. However, if the amount of appointed capital in a resource profile includes a large percentage of aggregated capital, the entrepreneur can be made aware that the participant has already received commitments to aggregate the capital from the following resource profiles. Similarly, a resource profile that includes aggregated resources may also identify the number of resource profiles from which resources are aggregated. This indication can inform the entrepreneur that the participant may be relying on a large number of other participants for the appointed resources.

To provide some confidence during the matching and negotiating processes, the profile matching website may employ ratings. In some embodiments, a rating may be assigned to each resource profile and business opportunity profile. The rating may represent the likelihood that the participant behind the resource profile will follow through with the contribution of the appointed resources or the likelihood that the entrepreneur behind the business opportunity profile will agree to reasonable terms. In some embodiments, a profile's rating can be based on previous interactions of the entrepreneur behind the business opportunity profile or the participant behind the resource profile. For example, after a participant has negotiated or otherwise interacted with an entrepreneur or another participant within the profile matching website, the entrepreneur or other participant can be given the opportunity to provide feedback for the participant and vice versa. This feedback can be aggregated into the rating for the participant or entrepreneur and ultimately for any profiles created by the participant or entrepreneur.

Feedback used to create a rating can be provided at various times. For example, after negotiating with a participant, an entrepreneur can be asked to provide feedback to rate the participant. This feedback can specify whether the participant represented accurate criteria within the resource profile (e.g. whether the participant made a substantial change to the terms initially presented in the resource profile once negotiations began), whether the participant had (or was able to obtain) the appointed resources once the terms of a potential agreement were reached (including when the participant aggregated resources), whether the participant was able to receive aggregated resources from other participants, etc. In the case of an entrepreneur, the feedback can specify similar information including whether the corresponding business opportunity profile was legitimate, or whether the entrepreneur was able to perform as described in the business opportunity profile.

In some embodiments where a resource profile includes aggregated resources, the rating for the resource profile can be based not only on the rating of the participant behind the resource profile, but also on the rating of any participant that has aggregated resources into the resource profile. Therefore, in such cases, the rating of the resource profile can represent the risk present due to the aggregation of resources. For example, a resource profile that would otherwise have a high rating if it did not include aggregated resources may be given a lower rating once resources are aggregated to represent that the resource profile relies on aggregated resources from one or more participants with lower ratings. Similarly, the rating of a resource profile may be increased if it includes resources aggregated from resource profiles with higher ratings.

In some embodiments, the rating of the resource profile that includes aggregated resources can be based on a weighting of the ratings of each resource profile from which resources are aggregated. In some instances, this weighting can be based on the percentage of each aggregated amount. For example, if the resource profile includes an aggregated appointed capital of $100,000 where $50,000 of the appointed capital has a rating of 100 and $50,000 has a rating of 70, each rating may be given the same weight so that the overall rating is 85. In contrast, if the aggregated appointed capital included $90,000 with a rating of 100 and $10,000 with a rating of 70, the 100 rating could be weighted as 90% of the overall rating while the 70 rating would be weighted as 10% of the overall rating giving an overall rating of 97. In this way, a participant having a resource profile with a high rating may not be substantially affected by allowing a participant with a lower rating to aggregate resources. In some embodiments, a rating of a resource profile can be affected by or based on ratings of following resource profiles in a similar manner as described above.

In some embodiments, an entrepreneur can preapprove a resource profile for a particular business opportunity profile. Preapproval of a resource profile means that the entrepreneur has agreed to terms specified in the resource profile for a specific business opportunity profile. The preapproval of the resources profile can indicate to other participants that, if they aggregate their resource profiles with the preapproved resource profile, their proposed resource is likely to be accepted. This preapproval may be particularly beneficial in situations where the participant behind the preapproved resource profile is ready to contribute but does not have the necessary resources. The preapproved status of the resource profile can indicate to other participants that aggregating with the preapproved resource profile will very likely lead to an acceptance of their aggregated resources.

In some embodiments, a business opportunity profile (or an entrepreneur) can be preapproved by a third party. As an example, the business opportunity profile may be the opening of a franchise for which the franchisor has already approved the entrepreneur. In such cases, the business opportunity profile can indicate preapproval by the franchisor to incentivize participants to select the preapproved business opportunity profile.

The profile matching website can include functionality for creating lists of profiles to follow. Following a resource profile differs from aggregating with a resource profile in that following a resource profile does not cause any resources to be aggregated with the followed resource profile. A participant may choose to follow a resource profile or a group of resource profiles for various reasons including to monitor any negotiations or bidding that is occurring in connection with the followed profile. For example, a participant may follow a resource profile in anticipation of aggregating with the resource profile.

In some embodiments, the participant behind a followed profile can be made aware of the other participants that are following it. In this way, the followed participant can reach out to the following participants to request that they aggregate with the followed resource profile at an appropriate or opportune time.

The profile matching website can also include functionality for creating lists of business opportunity profiles to watch. A participant may choose to watch a business opportunity profile or a group of business opportunity profiles. Watching differs from following in that an entrepreneur behind a watched business opportunity profile is not made aware of the watcher, but will be made aware of the follower. However, watching a business opportunity profile will still provide the watching participant with information regarding the status of the business opportunity profile.

The profile matching website may also provide functionality for a bank or other lending institution to refer failed loan applications to the profile matching website. For example, a bank may provide information to the profile matching website regarding one or more rejected loan applications. The bank and/or the profile matching website may then notify the applicants of the opportunity to pursue a resource match via the profile matching website. Each applicant that wishes to participate in the profile matching website, must agree to the terms and conditions to allow the creation of a business opportunity profile using information from the rejected loan application that was provided by the bank. In this way, an applicant may seamlessly receive access to potential capital in the profile matching website (via matching resource profiles to the applicant's business opportunity profile) even though the referring bank rejected the loan application.

In some embodiments, such as when the participant behind the resource profile is a lending institution, a resource profile may have appointed resources that do not decrement when the participant behind the business opportunity profile accepts terms of the resource profile. For example, in a typical scenario where the participant has limited funds, the acceptance of terms of a business opportunity profile will cause the appointed resources (or at least the amount agreed upon) of the resource profile to be decremented as evidence that the participant and entrepreneur have reached an agreement to pursue further negotiations. However, when the participant is a financial institution that has the capital necessary to fund multiple business opportunity profiles, an agreement may not cause the appointed capital to decrement. In this way, the participant can create a single resource profile that can be used to match multiple business opportunity profiles and will therefore not have to create multiple resource profiles that may have identical or at least substantially similar criteria.

FIG. 2 illustrates an example of a profile data structure 201 that can be employed to define a profile (whether the profile is a business opportunity profile or a resource profile) and a provider data structure 202 that can be employed to define a provider (whether the provider is a business opportunity provider or a resource provider). It is noted that data structures 201 and 202 are intended only to generally represent how profiles and providers can be defined. Therefore, even though a single data structure is shown as being used to define a profile or a provider, in many implementations, a number of data structures (e.g., a number of relational database tables) can be employed to define a profile or a provider.

As shown in FIG. 2, profile data structure 201 includes a number of fields including a profile ID field which can define a unique identifier for the profile, a profile type field which can define a type of the profile (e.g., a business opportunity profile or a resource profile), a provider ID field which can identify the provider that created the profile, a name field which can define a name for the profile, and a number of attribute fields which can define attributes of the profile (e.g., whether the profile is followable, and if so, identifiers of any following profiles, an amount and/or type of resource appointed to the profile, a rating of the profile, whether the profile includes aggregated amounts, and if so, identifiers of profiles that have aggregated, whether the profile is preapproved, etc.). As indicated by the ellipsis, profile data structure 201 may include a number of additional fields beyond those shown in FIG. 2.

Provider data structure 202 also includes a number of fields including a provider ID field which defines a unique identifier for the provider, a provider name field that defines the name of the provider, and a provider address field which defines an address of the provider. As indicated by the ellipsis, provider data structure 202 may also include a number of additional fields beyond those shown in FIG. 2.

Whenever a provider creates a profile, an instance of profile data structure 201 can be created (e.g., a unique entry in a database can be created to store the values assigned to the fields of profile data structure 201). Because each instance of profile data structure 201 includes a provider ID field, each instance will be mapped back to a particular provider. In other words, there can be a one-to-many relationship between a provider and profiles.

FIGS. 2A and 2B each illustrate an example of how a provider can create multiple profiles. FIG. 2A represents the case when a provider has created two business opportunity profiles. In particular, a provider data structure 202a includes a provider ID of 12345 for a provider named John Smith having an address of 123 Main. As indicated by profile data structures 201a1 and 201a2 both having a provider ID field having a value matching John Smith's provider ID, John Smith has created two business opportunity profiles. John Smith has named the first business opportunity profile ABC, LLC as defined by profile data structure 201a1. Additionally, John Smith has indicated that he is seeking $50,000 as debt and a CEO. As indicated above, profile data structure 201a1 could also include a number of additional fields/attributes defining aspects of the business opportunity. Similarly, John Smith has named the second business opportunity profile XYZ, LLC as defined by profile data structure 201a2. Additionally, John Smith has indicated that he is seeking $100,000 in exchange for equity in XYZ, LLC. Although not shown in FIG. 2A, if John Smith were to create a resource profile, an appropriate profile data structure could be created to define the resource profile.

FIG. 2B represents an example where a provider, Mike Smith, has created two resource profiles each of which include a provider ID pointing back to Mike Smith's provider data structure 202b. A first resource profile, as defined by profile data structure 201b1, is named Investment, LLC and defines a number of attributes including that Mike Smith has appointed $150,000 to the resource profile, that the resource profile is followable, and that $50,000 has been aggregated to the appointed $150,000. The attributes can also include the profile IDs of any profile that is following the resource profile or that has aggregated with the resource profile. As can be seen, profile data structure 201b1 can be updated as other providers select to follow and/or aggregate with the resource profile. Similarly, a second resource profile, as defined by profile data structure 201b2, is named Real Estate Portfolio and defines an appointment of $350,000 to the resource profile. In this case, it can be assumed that Mike Smith has indicated that this resource profile is not followable.

The particular format employed to define profiles can be selected to facilitate searching and matching of profiles. For example, many different types of attributes can be included in profile data structure 201 to facilitate searching and matching at granular levels. Additionally, these attributes can be configured to facilitate the identification of whether a profile includes aggregated profiles and, if so, an amount that is aggregated.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

1-27. (canceled)

28. A method for creating multiple resource profiles for a single participant within a profile matching website to enable matching of business opportunity profiles with resource profiles, the method comprising:
receiving first user input from a first participant, the first user input defining a first resource profile for the first participant, the first resource profile defining a first amount of money the first participant desires to contribute to a business opportunity profile that matches first criteria also defined in the first resource profile;
receiving second user input from the first participant, the second user input defining a second resource profile for the first participant, the second resource profile defining a second amount of money the first participant desires to contribute to a business opportunity profile that matches second criteria also defined in the second resource profile; and
storing the first and second resource profiles for the first participant such that the first and second resource profiles can be searched to identify whether the first or second criteria match attributes of one or more business opportunity profiles.

29. The method of claim 28, wherein the first amount of money and the second amount of money are the same.

30. The method of claim 28, wherein the first criteria and the second criteria are different.

31. The method of claim 28, wherein one or both of the first and second criteria defines that the first participant will provide skills in addition to the first or second amount of money.

32. The method of claim 28, wherein the first criteria defines that the first participant will provide first services, and the second criteria defines that the first participant will provide second services that are different than the first services.

33. The method of claim 28, wherein one or both of the first and second criteria defines that the first participant is willing to provide the first or second amount of money respectively in a business opportunity if another participant is willing to provide another amount of money or services in the business opportunity.

34. The method of claim 28, wherein at least one of the first or second resource profiles allows aggregation thereby allowing one or more other participants to aggregate an amount of money or skills into the first or second resource profile.

35. The method of claim 28, wherein at least one of the first or second resource profiles is preapproved by a business opportunity profile.

36. The method of claim 28, further comprising at least one of:
creating a first business opportunity profile that is preapproved by a third party;
receiving, from a lending institution, information regarding one or more rejected loan applications;
receiving, from an applicant of the one or more rejected loan applications, a request to create a business opportunity profile;
creating the business opportunity profile from the information received from the lending institution;
associating a rating with each of the first and second resource profile, the rating for each resource profile being based on input received from one or more other participants and/or entrepreneurs;
receiving third user input from a second participant, the third user input defining a first business opportunity profile for the second participant;
receiving fourth user input from the second participant, the fourth user input defining a second business opportunity profile for the second participant; and
storing the first and second business opportunity profiles for the second participant such that the first and second business opportunity profiles can be searched to identify whether any resource profiles include criteria matching attributes of the first or second business opportunity profiles.

37. A method for enabling participants to aggregate resources into a single resource profile, the method comprising:
receiving user input from a first participant, the user input defining a first resource profile for the first participant, the first resource profile defining a first amount of money the first participant is willing to contribute to a business opportunity;
receiving user input from the first participant that identifies the first resource profile as allowing aggregation;
receiving user input from a second participant that requests that a second resource profile of the second participant be aggregated with the first resource profile, the second resource profile defining a second amount of money the second participant is willing to contribute to a business opportunity; and
modifying the first resource profile to include the second amount of money defined by the second resource profile such that an entrepreneur, when viewing the first resource profile, will see that the first resource profile includes an aggregated amount of money that includes the first and second amounts.

38. The method of claim 37, wherein the first resource profile includes a rating, and wherein modifying the first resource profile includes modifying the rating of the first resource profile based on a rating of the second resource profile.

39. The method of claim 37, further comprising at least one of:
receiving user input from an entrepreneur that selects the first resource profile;
providing an interface for the first participant and the entrepreneur to negotiate terms for accepting the aggregated amount;
displaying the first resource profile to an entrepreneur, wherein the display includes an indication between any participant and the entrepreneur; and
displaying the first resource profile to an entrepreneur, wherein the display includes an indication of the aggregated amount and the first amount.

40. The method of claim 39, wherein the interface enables one or more other participants behind one or more other resource profiles to negotiate terms for accepting amounts defined in the one or more other resource profiles.

41. The method of claim 37, wherein the aggregated amount includes a third amount of money defined by a third resource profile that follows the first resource profile.

42. A method for employing a resource profile within a profile matching website, the method comprising:
creating a resource profile for a first participant, the resource profile defining an amount of money to be used to search for a business opportunity profile;
assigning a rating to the resource profile, the rating being based on feedback received for the first participant from one or more entrepreneurs or other participants with whom the first participant interacted previously within the profile matching website.

43. The method of claim 42, wherein the resource profile allows aggregation, the method comprising adjusting the rating of the resource profile based on a rating of another resource profile that is aggregated with the resource profile.

44. The method of claim 42, further comprising defining an aggregated amount in the resource profile by increasing the amount of money defined in the resource profile by an amount defined within another resource profile that is aggregated with the resource profile.

45. The method of claim 42, further comprising at least one of:
aggregating another resource profile to the resource profile, the other resource profile defining one or more services such that the resource profile defines the amount of money and the one or more services;
aggregating another resource profile to the resource profile, the other resource profile defining one or more services such that the resource profile defines the amount of money and the one or more services;
receiving user input from an entrepreneur that selects the resource profile;
displaying an interface within which the entrepreneur and the first participant negotiate terms for accepting the aggregated amount; and
creating a second resource profile for the second participant.
